(19) United States
(12) Patent Application Publication
(10) Pub. No.: US 2017/0150560 A1
(43) Pub. Date: May 25, 2017

(54) COLORFUL LED LIGHT STRING

(71) Applicant: JLJ, Inc., Bellbrook, OH (US)

(72) Inventor: John L. Janning, Bellbrook, OH (US)

(21) Appl. No.: 15/341,747

(22) Filed: Nov. 2, 2016

Related U.S. Application Data
(63) Continuation-in-part of application No. 15/244,714, filed on Aug. 23, 2016, now Pat. No. 9,510,423.
Application No. 15/244,714 is a continuation of application No. 15/008,213, filed on Jan. 27, 2016, now Pat. No. 9,433,057.
(60) Provisional application No. 62/413,623, filed on Oct. 27, 2016.
(60) Provisional application No. 62/258,503, filed on Nov. 22, 2015.
(60) Provisional application No. 62/260,505, filed on Nov. 28, 2015.
(60) Provisional application No. 62/262,779, filed on Dec. 3, 2015.
(60) Provisional application No. 62/262,994, filed on Dec. 4, 2015.

(51) Int. Cl. H05B 33/08

(52) U.S. Cl. CPC H05B 33/089; H05B 33/0827; H05B 33/0809

(57) ABSTRACT

A series-wired LED light string formed of a plurality of sockets, each of which receives an LED housing containing a pair of LEDs connected in anti-parallel configuration and driven by AC voltage. By selecting and combining appropriate colored LEDs, the series wired string can emit light in a variety of different colors, including pastel colors by combining a white LED with a colored LED in an anti-parallel pair. Each LED socket may optionally include a protective resistive component which is electrically connected in parallel across each pair of anti-parallel LEDs to protect each LED of the pair from reverse voltage breakdown damage in the event of a failure of the other LED in the housing. The protective resistive component may be a resistor or a thermistor.

This is a continuation-in-part of U.S. patent application Ser. No. 15/244,714, filed on Aug. 23, 2016, which is a continuation of U.S. patent application Ser. No. 15/008,213, filed on Jan. 27, 2016, now U.S. Pat. No. 9,433,057, which claims priority to U.S. Provisional Application No. 62/258,503, filed Nov. 22, 2015, U.S. Provisional Application No. 62/260,505, filed Nov. 28, 2015, U.S. Provisional Application No. 62/262,779, filed Dec. 3, 2015, and U.S. Provisional Application No. 62/262,994, filed Dec. 4, 2015, the disclosures of which are herein incorporated by reference. This application also claims priority to U.S. Provisional Application No. 62/413,623, filed on Oct. 27, 2016.

### FIELD OF THE INVENTION

The present invention relates to a series connected light string and, more particularly to an LED light string with anti-parallel wired LED pairs connected in electrical series for colorful holiday lighting.

### BACKGROUND OF THE INVENTION

Light Emitting Diode (LED) light strings have become quite popular recently for Christmas holiday decorating. They are much more energy efficient than incandescent lighting that has been around for many years. Since both the LED and the more conventional incandescent mini-light operate at very low voltage—usually between 2.0 to 3.5 volts—they are wired in electrical series connection with approximately 35 to 50 lights in a light string. As with incandescent lighting, when an LED bulb burns out or otherwise fails, the entire series light string goes out. To prevent this, bypass shunts can be wired across each LED to continue current through the light string in the event of such a failure. Such shunts are often resistive shunts, such as disclosed in U.S. Pat. Application No. 2014/0042903.

The latest trend in pre-lit Christmas trees is two color trees. This is where the consumer may choose clear (white) lights or multi-color lights to illuminate the Christmas tree. Inside each LED housing 2 is two LED's 4, 6—one clear and one color—connected in anti-parallel, as shown in FIG. 1. Such anti-parallel LED pairs are provided in a DC powered series wired circuit so that all clear LED's (oriented in one direction) are connected in electrical series and all multi-colored LED's (oriented in an opposite direction) are so wired. Selecting which color the tree will illuminate is easy. This can be done by flipping a switch 8, as shown in FIG. 2.

A bridge rectifier 10 provides full wave low flicker rectification to the LEDs. When current flows in one direction, the clear lights illuminate. When the polarity is switched, the current flows in the opposite direction, illuminating the multi-colored LED's. Because the voltage to the multi-colored LED's average lower than the clear lights, a series resistor 12 is inserted in the multi-color circuit. This series resistor can be shunted by a rectifier diode (D1) 14 (FIG. 2) which also may have a series resistor in series with it. This means keeps the proper current flowing in the circuit.

While LED's claim a long life, they do sometimes fail. When they are connected anti-parallel as shown in FIG. 1, each LED protects the companion LED in that housing from reverse voltage breakdown. When an LED fails, it no longer can protect its companion LED and that LED is damaged, and both colored light strings go out. U.S. Pat. No. 9,433,057 discloses and claims a circuit for anti-parallel LEDs which protects the companion LED of each anti-parallel pair from reverse voltage breakdown in the event of failure of one of the two LEDs, thereby allowing a light string formed of anti-parallel LEDs to remain lit. Such a circuit is described below with reference to FIGS. 1-3 of the present application,

Present day LED Christmas light strings come in white lights or colored lights. Color LED light strings usually consists of about five different colors. Such a light string emits only those colors. It would be desirable to provide an LED Christmas light string with more colors.

### SUMMARY OF THE INVENTION

The present invention provides a colorful, series wired light string with two color LED chips in each housing, connected in anti-parallel, and powered by AC voltage. The colors of the LEDs in each housing blend in the eye of the viewer to create unique colors, such as pastels, not otherwise obtainable in an LED light string.

Optionally, a resistive shunt may be provided across each pair of anti-parallel LEDs to not only keep the current flowing in the direction of the failed LED (so that the other LEDs in the same direction in the string remain lit), but it also advantageously protects the companion LED from reverse voltage damage, thereby preventing failure of the entire light string.

Other advantages, variations and other features of the invention will become apparent from the drawings, the further description of examples and the claims to follow.

### BRIEF DESCRIPTION OF THE DRAWINGS

FIG. 1 shows two LEDs connected in an anti-parallel configuration.

FIG. 2 shows a light string with a series of anti-parallel LED pairs, including a resistive shunt to protect the LEDs against reverse voltage breakdown; and

FIG. 3 shows a transient voltage suppressor (TVS) device which can be used as a resistive shunt in the present invention.

FIG. 4 shows a light string with a series of anti-parallel LED pairs, powered by AC voltage.

FIG. 5 shows a light string similar to FIG. 4, but with a resistive shunt across each anti-parallel diode pair to protect the LEDs against reverse voltage breakdown.

### DETAILED DESCRIPTION OF THE PREFERRED EMBODIMENTS

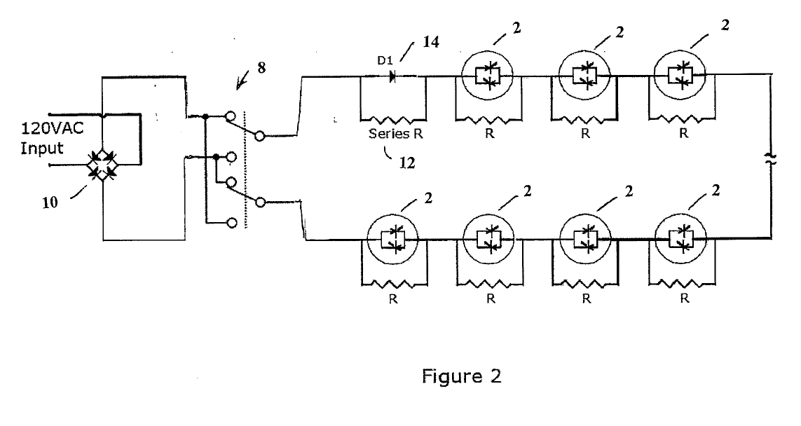

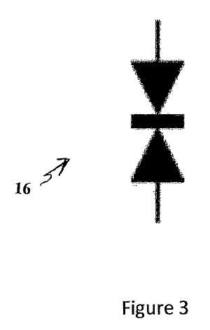

With reference to FIG. 2, to protect the companion LED of each pair of anti-parallel LEDs from reverse voltage breakdown, the circuit of the present invention advantageously includes a resistive component R such as a resistor; NTC (negative temperature coefficient) thermistor, a TVS (transient voltage suppressor) 16 (see FIG. 3), or a metal oxide varistor (MOV) connected across the terminals of the LEDs or preferably inside the LED socket.

In the event of a failure of one of the LEDs in each pair of anti-parallel LEDs, the resistive shunt not only keeps the current flowing in the direction of the failed LED (so that the other LEDs of same color in the circuit remain lit), but it also advantageously protects the companion LED from reverse voltage damage.

By way of further explanation, with the parallel connected protective resistive component of the present invention, the dual color Christmas light string operates normally. Each LED in the LED housing protects the other (companion) LED from reverse voltage breakdown damage. However, if an LED goes out, that LED itself goes out. All of the others stay lit. While the bad LED no longer protects its companion, the parallel connected protective resistive component protects the companion LED from reverse voltage damage. The entire series wired string of that color is thus unaffected by the failure of a single LED.

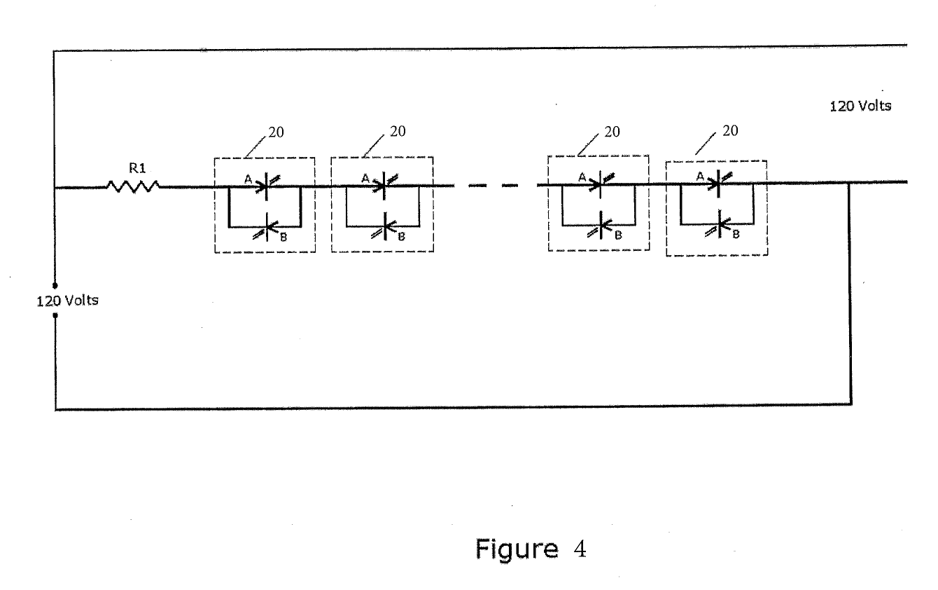

FIG. 4 shows a further embodiment of the invention, namely a series wired light string which is designed to emit a variety of different colors, including pastel colors. LED Christmas light strings typically come in white lights or colored lights. In respect to colored lights, a present day color LED light string usually consists of about five colors. Such a typical light string would emit only those colors.

In accordance with the embodiment of the present invention shown in FIG. 4, different color LED chips are provided in the same housing 20 in an anti-parallel configuration, and the LEDs of the series wired light string are powered with AC voltage, rather than DC voltage. When a 60 cycle AC voltage is applied to a series-wired light string, all of the LEDs that are forward biased (e.g., the LEDs labelled “A” in FIG. 4) will illuminate in their respective color for the first 120^{th} of a second, followed by the illumination of the other LEDs in their respective housings (the LEDs labelled “B”) that are initially reversed biased, but then are forward biased for the second 120^{th} of a second—this alternate illumination of the anti-parallel LEDs in each housing will repeat 60 times each second, resulting in the human eye seeing the mixing of the LED colors to form an apparent new color, which is a blend of the colors of the LEDs in the pair. Thus, when red and blue LED chips, for example, are connected in anti-parallel configuration are powered by the standard 60 cycle house current, the light from that LED housing is not actually purple, but rather is alternatively red and blue, changing 120 times a second. However, the human eye cannot react so quickly, and thus the relatively slow response of the human eye makes it appear to the viewer that the output light is purple.

One example of an extended color would be a green LED and a white LED in the same housing connected in anti-parallel configuration, yielding a light green pastel color. Similarly, as described above, a blue and red LED would yield a purple color. Many possibilities are possible. Using present day LED colors of red, yellow, green, blue and white, by mixing colors in accordance with the present invention, fourteen colors are possible, excluding white.

As an example, a light string with 35 LED pairs configured in accordance with the present invention might contain the following anti-parallel wired LEDs: 3 blue/blue pairs, 3 red/red pairs, 3 yellow/yellow pairs, 3 green/green pairs, 3 red/blue pairs, 3 green/blue pairs, 3 red/yellow pairs, 3 red/green pairs, 3 red/white pairs, 3 yellow/white pairs, 3 green/white pairs and 2 blue light pairs. Thus, in a preferred embodiment, a colorful light string would contain some same color LED chips in anti-parallel pairs, as well as some different color LED chips in anti-parallel pairs.

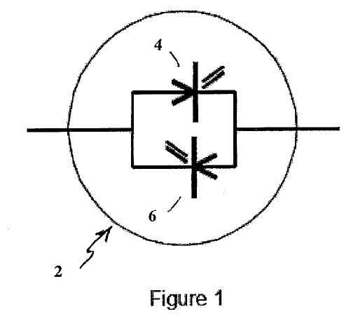

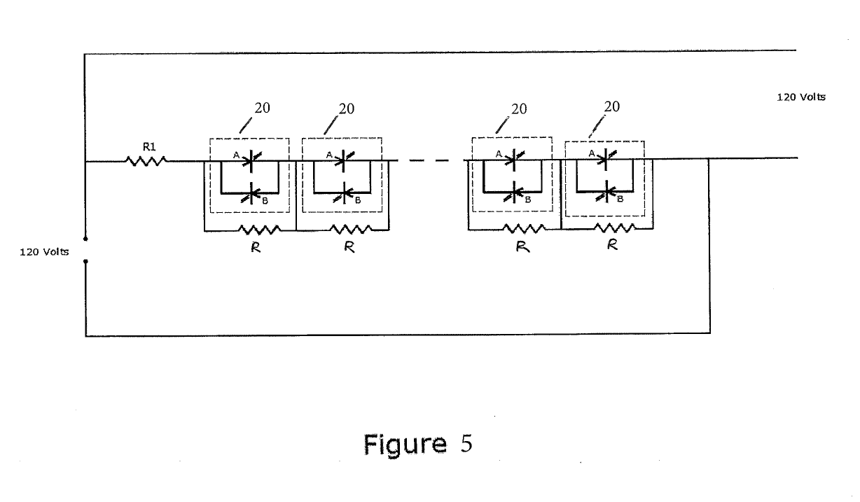

FIG. 5 shows the inclusion of shunts R across each anti-parallel pair to keep the string operating in case of an LED failure or if the LED is loose or missing from the socket. As with the embodiment of FIG. 1, the shunt can be a resistor or a thermistor. A series resistor R1 is also included, as in the prior embodiment.

Although the invention has been described in detail in connection with the exemplary embodiments, it should be understood that the invention is not limited to the above disclosed embodiments. Rather, the invention can be modified to incorporate any number of variations, alternations, substitutions, or equivalent arrangements not heretofore described, but which are commensurate with the spirit and scope of the invention. Accordingly, the invention is not limited by the foregoing description or drawings, but is only limited by the scope of the appended claims.

What is claimed is:

1. A colorful series-wired LED light string comprising:
a plurality of series connected LED housings, each housing containing a pair of LEDs connected in anti-parallel configuration and powered with AC voltage, such that each LED in the pair is forward biased when the other LED of the pair is reverse biased;
wherein the LEDs of each pair emit colored light, whereby all of the LEDs of the light string that are forward biased will illuminate in their respective color for the first 120^{th} of a second, followed by the illumination of the other LEDs in the light string in the second 120^{th} of a second, the process repeating 60 times per second, such that a person viewing the light string will see, from each housing, light from each housing representing a mixture of the respective colors emitted by the two anti-parallel connected LEDs in the housing.

2. A colorful series-wired LED light string as recited in claim 1, wherein at least some of the LED housings of the light string include different color LEDs.

3. A colorful series-wired LED light string as recited in claim 2, wherein at least some of the LED housings of the light string include same color LEDs.

4. A colorful series-wired LED light string as recited in claim 1, wherein at least some of the LED housings of the light string include one white LED and one LED from the group consisting of red, yellow, green and blue, thereby yielding a pastel colored output in the eye of the viewer.

5. A colorful series-wired LED light string as recited in claim 1, further comprising a current limiting resistor disposed in series with the LED housings to control the current in the light string.

6. A colorful series-wired LED light string as recited in claim 1, further comprising a protective resistive component disposed parallel with the pair of anti-parallel LEDs in each of the LED housings.

7. A colorful series-wired LED light string as recited in claim 6, wherein, in the event of a failure of an LED in the housing, the protective resistive component further serves as a shunt to electrically bypass the failed LED and keep the remaining LEDs in the light string fully illuminated.

8. A colorful series-wired LED light string as recited in claim 7, wherein the protective resistive component is a resistor.

9. A colorful series-wired LED light string as recited in claim 7, wherein the protective resistive component is a thermistor.
